(19) United States
(12) Patent Application Publication
(10) Pub. No.: US 2024/0331145 A1
(43) Pub. Date: Oct. 3, 2024

(54) IMAGE PROCESSING APPARATUS, IMAGE PROCESSING METHOD, AND IMAGE PROCESSING PROGRAM

(71) Applicant: FUJIFILM Corporation, Tokyo (JP)

(72) Inventor: Aya OGASAWARA, Tokyo (JP)

(73) Assignee: FUJIFILM Corporation, Tokyo (JP)

(21) Appl. No.: 18/596,646

(22) Filed: Mar. 6, 2024

(30) Foreign Application Priority Data
Mar. 28, 2023 (JP) 2023-051230

(51) Int. Cl. G06T 7/00; G06T 7/70

(52) U.S. Cl. CPC G06T 7/0012; G06T 7/70; G06T 2207/20084; G06T 2207/30096

(57) ABSTRACT

An image processing apparatus determines a position of an indirect finding associated with occurrence of a lesion in a medical image based on input information including a position of the lesion, and generates a medical image in which the indirect finding is generated at the determined position in a normal medical image in which the lesion has not occurred or in an abnormal medical image in which the lesion has occurred.

### CROSS-REFERENCE TO RELATED APPLICATIONS

This application claims priority from Japanese Patent Application No. 2023-051230, filed on Mar. 28, 2023, the entire disclosure of which is incorporated herein by reference.

### BACKGROUND

### 1. Technical Field

The present disclosure relates to an image processing apparatus, an image processing method, and an image processing program.

### 2. Description of the Related Art

JP2021-019677A discloses a technique of detecting an air space region on a first image obtained by imaging a cross section of a lung in which an air space is generated due to a first disease, and generating, based on the first image and a second image showing a shadow of a tumor due to a second disease that may cause complications with the first disease, a third image in which the first image is combined with the second image. In this technique, in a case in which the second image is disposed on the first image, the third image in which the first image is combined with the second image is generated by hiding a portion of the shadow of the tumor that overlaps the detected air space region.

### SUMMARY

In a case in which a trained model for detecting a lesion from a medical image is generated by machine learning, it is preferable to collect a large amount of learning data in order to improve detection accuracy of the lesion. In many cases, the lesion is discovered after the progression, and it may be difficult to collect a medical image of the lesion in an early stage. In this case, it is preferable to be able to accurately generate the medical image of the lesion in an early stage, because the generated medical image can be used for machine learning.

The present disclosure has been made in view of the above circumstances, and an object of the present disclosure is to provide an image processing apparatus, an image processing method, and an image processing program capable of accurately generating a medical image of a lesion in an early stage.

According to a first aspect, there is provided an image processing apparatus comprising: at least one processor, in which the processor determines a position of an indirect finding associated with occurrence of a lesion in a medical image based on input information including a position of the lesion, and generates a medical image in which the indirect finding is generated at the determined position in a normal medical image in which the lesion has not occurred or in an abnormal medical image in which the lesion has occurred.

A second aspect provides the image processing apparatus according to the first aspect, in which the input information including the position of the lesion is a position of the lesion in the abnormal medical image.

A third aspect provides the image processing apparatus according to the first aspect, in which the input information including the position of the lesion is a probability map in which a probability of occurrence of the lesion is defined for each position in the medical image.

A fourth aspect provides the image processing apparatus according to the first aspect, in which the input information including the position of the lesion is data in which a value indicating existence of the lesion is defined in a region in which the lesion exists in the medical image.

According to a fifth aspect, there is provided an image processing method executed by a processor of an image processing apparatus, the method comprising: determining a position of an indirect finding associated with occurrence of a lesion in a medical image based on input information including a position of the lesion; and generating a medical image in which the indirect finding is generated at the determined position in a normal medical image in which the lesion has not occurred or in an abnormal medical image in which the lesion has occurred.

According to a sixth aspect, there is provided an image processing program for causing a processor of an image processing apparatus to execute: determining a position of an indirect finding associated with occurrence of a lesion in a medical image based on input information including a position of the lesion; and generating a medical image in which the indirect finding is generated at the determined position in a normal medical image in which the lesion has not occurred or in an abnormal medical image in which the lesion has occurred.

According to the present disclosure, it is possible to accurately generate a medical image of a lesion in an early stage.

### BRIEF DESCRIPTION OF THE DRAWINGS

FIG. 1 is a block diagram showing a schematic configuration of a medical information system.

FIG. 2 is a block diagram showing an example of a hardware configuration of an image processing apparatus.

FIG. 3 is a block diagram showing an example of a functional configuration of the image processing apparatus.

FIG. 4 is a diagram for describing a trained model.

FIG. 5 is a diagram for describing a process of generating a medical image using the trained model.

FIG. 6 is a flowchart showing an example of a medical image generation process.

FIG. 7 is a diagram for describing a process of generating a medical image using a trained model according to a modification example.

FIG. 8 is a diagram for describing a process of generating a medical image using a trained model according to a modification example.

FIG. 9 is a diagram for describing a process of generating a medical image using a trained model according to a modification example.

### DETAILED DESCRIPTION

Hereinafter, examples of an embodiment for implementing the technique of the present disclosure will be described in detail with reference to the drawings.

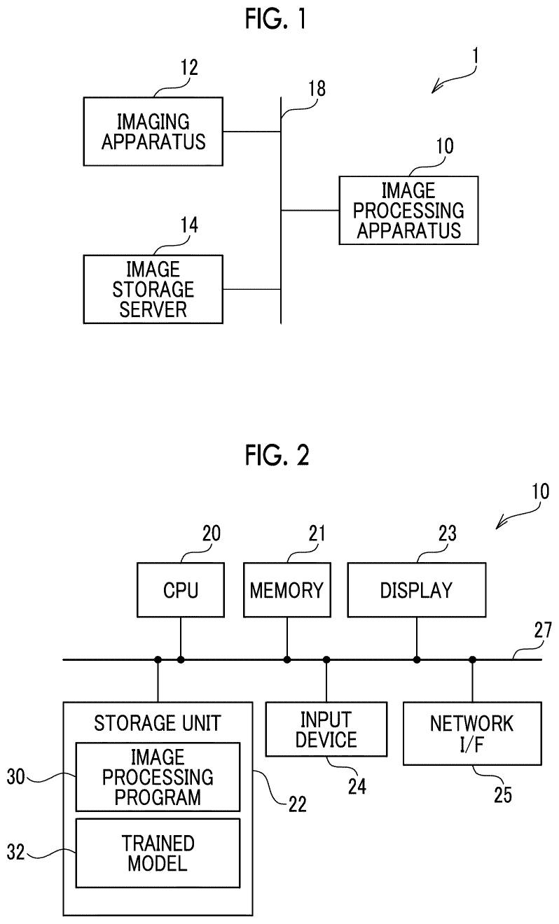

First, a configuration of a medical information system 1 according to the present embodiment will be described with reference to FIG. 1. As shown in FIG. 1, the medical information system 1 includes an image processing apparatus 10, an imaging apparatus 12, and an image storage server 14. The image processing apparatus 10, the imaging apparatus 12, and the image storage server 14 are connected to each other in a communicable manner via a wired or wireless network 18. The image processing apparatus 10 is, for example, a computer such as a personal computer or a server computer.

The imaging apparatus 12 is an apparatus that generates a medical image showing a diagnosis target part of a subject by imaging the part. Examples of the imaging apparatus 12 include a simple X-ray imaging apparatus, an endoscope apparatus, a computed tomography (CT) apparatus, a magnetic resonance imaging (MRI) apparatus, and a positron emission tomography (PET) apparatus. In the present embodiment, an example will be described in which the imaging apparatus 12 is a CT device and the diagnosis target part is an abdomen. That is, the imaging apparatus 12 according to the present embodiment generates a CT image of the abdomen of the subject as a three-dimensional medical image formed of a plurality of tomographic images. The medical image generated by the imaging apparatus 12 is transmitted to the image storage server 14 via the network 18 and stored by the image storage server 14.

The image storage server 14 is a computer that stores and manages various types of data, and comprises a large-capacity external storage device and database management software. The image storage server 14 receives the medical image generated by the imaging apparatus 12 via the network 18, and stores and manages the received medical image. A storage format of image data by the image storage server 14 and the communication with another device via the network 18 are based on a protocol such as digital imaging and communication in medicine (DICOM).

Next, a hardware configuration of the image processing apparatus 10 according to the present embodiment will be described with reference to FIG. 2. As shown in FIG. 2, the image processing apparatus 10 includes a central processing unit (CPU) 20, a memory 21 as a temporary storage region, and a non-volatile storage unit 22. In addition, the image processing apparatus 10 includes a display 23 such as a liquid crystal display, an input device 24 such as a keyboard and a mouse, and a network interface (I/F) 25 that is connected to the network 18. The CPU 20, the memory 21, the storage unit 22, the display 23, the input device 24, and the network I/F 25 are connected to a bus 27. The CPU 20 is an example of a processor according to the technique of the present disclosure.

The storage unit 22 is realized by a hard disk drive (HDD), a solid state drive (SSD), a flash memory, or the like. An image processing program 30 is stored in the storage unit 22 as a storage medium. The CPU 20 reads out the image processing program 30 from the storage unit 22, expands the image processing program 30 in the memory 21, and executes the expanded image processing program 30.

In addition, a trained model 32 is stored in the storage unit 22. Details of the trained model 32 will be described below.

Incidentally, in order to discover the lesion early, it is preferable to collect a medical image of the lesion in an early stage. This is because the medical image can be used for, for example, machine learning. However, in some cases, the lesion is rarely discovered early and is discovered after the progression. In this case, it is preferable to be able to generate the medical image of the lesion in an early stage, because the medical image of the lesion in an early stage is rare.

Specifically, for example, in a case of a pancreatic cancer, in an early stage, localized pancreatic atrophy is noted as an indirect finding. The localized pancreatic atrophy means constriction. In a case in which the pancreatic cancer progresses, the cancer is increased to a size enough to be visible in a constriction portion, and then the size of the cancer is increased as the cancer further progresses.

The image processing apparatus 10 according to the present embodiment has a function of generating a medical image of a lesion in an early stage, based on a medical image including the lesion. In the following, an example will be described in which the pancreas is applied as an organ, which is a target in which the lesion is generated, the pancreatic cancer is applied as the lesion, and the constriction is applied as the indirect finding.

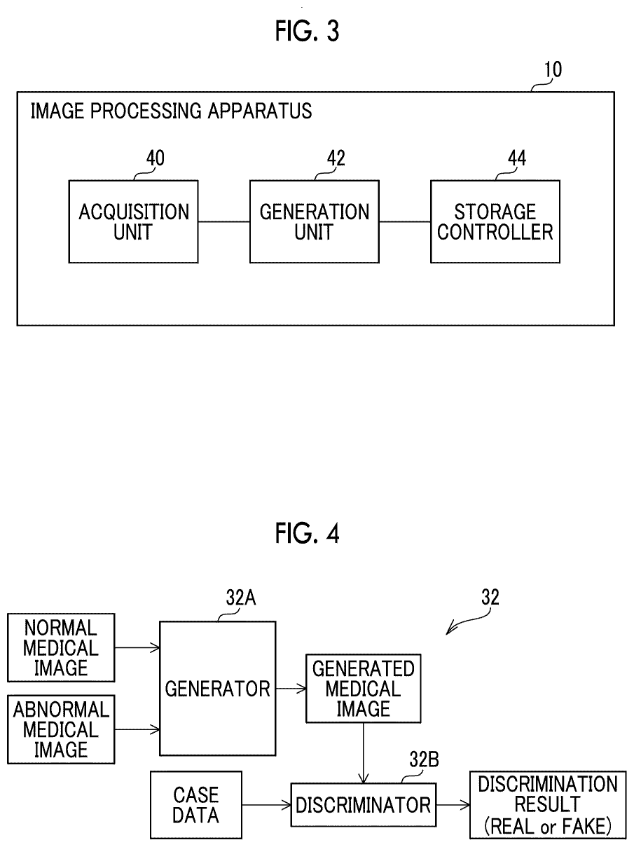

Next, a functional configuration of the image processing apparatus 10 according to the present embodiment will be described with reference to FIG. 3. As shown in FIG. 3, the image processing apparatus 10 includes an acquisition unit 40, a generation unit 42, and a storage controller 44. The CPU 20 executes the image processing program 30 to function as the acquisition unit 40, the generation unit 42, and the storage controller 44.

The acquisition unit 40 acquires a medical image in which the lesion has not occurred (hereinafter, referred to as a “normal medical image”) and a medical image in which a lesion has occurred (hereinafter, referred to as an “abnormal medical image”) from the image storage server 14 via the network I/F 25.

The generation unit 42 determines a position of an indirect finding associated with the occurrence of the lesion based on input information including a position of the lesion in the medical image and the trained model 32, and generates a medical image in which the indirect finding is generated at a determined position in the normal medical image acquired by the acquisition unit 40.

Details of the trained model 32 will be described with reference to FIG. 4. The trained model 32 according to the present embodiment is a generative model called a generative adversarial network (GAN). As shown in FIG. 4, the trained model 32 includes a generator 32A and a discriminator 32B. Each of the generator 32A and the discriminator 32B is configured by, for example, a convolutional neural network (CNN).

In a learning phase, a set of the normal medical image and the abnormal medical image is input to the generator 32A as learning data. The normal medical image and the abnormal medical image may be images of the same patient or may be images of different patients. The generator 32A determines a position of an indirect finding associated with the occurrence of the lesion based on a position of the lesion in the input abnormal medical image, and generates and outputs a medical image in which the indirect finding is generated at a determined position in the input normal medical image. Hereinafter, the medical image generated by the generator 32A is referred to as a “generated medical image”. In the present embodiment, the generator 32A generates a medical image in which constriction is generated at a position, which corresponds to a position of the pancreatic cancer in the abnormal medical image, in the normal medical image.

The discriminator 32B discriminates whether the generated medical image is a real medical image or a fake medical image by comparing prepared case data with the generated medical image output from the generator 32A. Then, the discriminator 32B outputs information indicating whether the generated medical image is a real medical image or a fake medical image as a discrimination result. As the discrimination result, a probability that the generated medical image is a real medical image is used. In addition, as the discrimination result, two values such as “1” indicating that the generated medical image is a real medical image and “0” indicating that the generated medical image is a fake medical image are used. The case data according to the present embodiment is an actual medical image obtained by imaging, with the imaging apparatus 12, a patient in whom constriction, which is an indirect finding of the pancreatic cancer in an early stage, has occurred.

The generator 32A is trained to be able to generate a generated medical image closer to a real medical image (that is, case data). The discriminator 32B is trained to more accurately discriminate whether the generated medical image is a fake medical image. For example, a loss function in which a loss of the discriminator 32B increases as a loss of the generator 32A decreases is used to perform learning such that the loss of the generator 32A is minimized in training the generator 32A. On the other hand, the loss function is used to perform learning such that the loss of the discriminator 32B is minimized in training the discriminator 32B. The trained model 32 is a model obtained by alternately training the generator 32A and the discriminator 32B using a large amount of learning data.

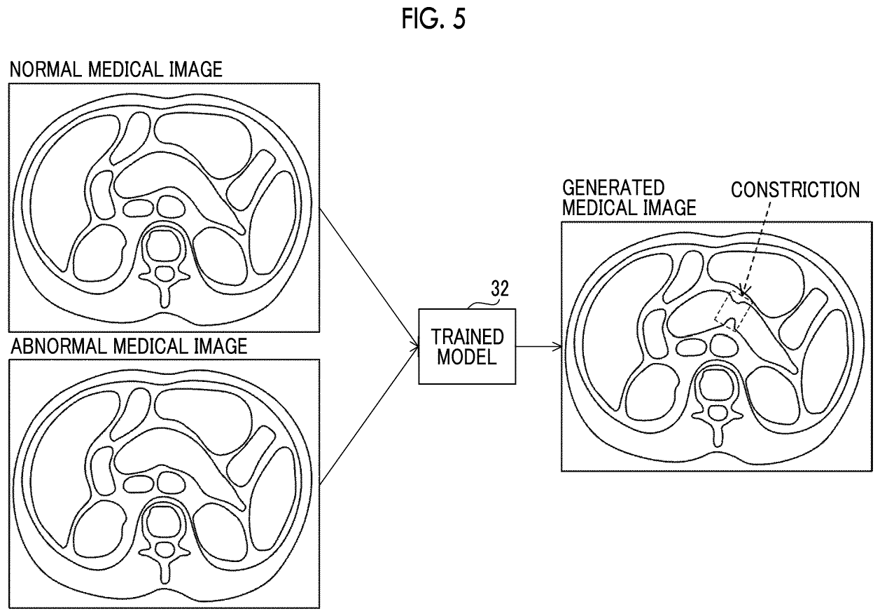

As shown in FIG. 5, the generation unit 42 inputs the normal medical image and the abnormal medical image acquired by the acquisition unit 40 to the trained model 32. The trained model 32 outputs a generated medical image in which an indirect finding is generated at a position, which corresponds to a position of the lesion in the abnormal medical image, in the normal medical image. As a result, the generation unit 42 generates the generated medical image. That is, the position of the lesion in the abnormal medical image acquired by the acquisition unit 40 is an example of the input information including the position of the lesion in the medical image. In the example of FIG. 5, a constriction portion that is an example of the indirect finding of the pancreatic cancer is indicated by a broken-line rectangle.

The storage controller 44 performs control to store the generated medical image generated by the generation unit 42 in the storage unit 22.

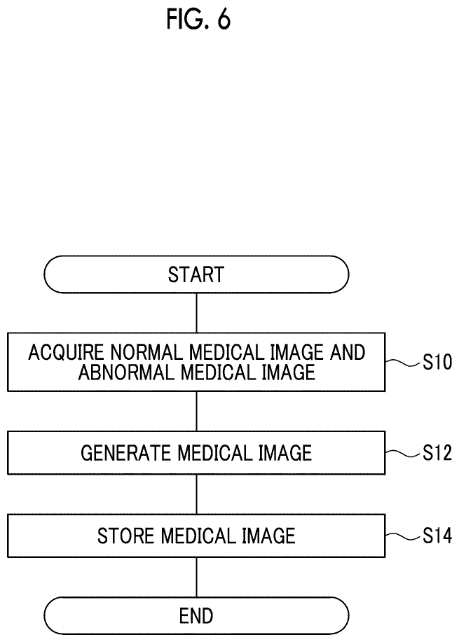

Next, an operation of the image processing apparatus 10 according to the present embodiment will be described with reference to FIG. 6. The CPU 20 executes the image processing program 30 to execute a medical image generation process shown in FIG. 6. The medical image generation process shown in FIG. 6 is executed, for example, in a case in which an instruction to start an execution is input by a user.

In step S10 of FIG. 6, the acquisition unit 40 acquires the normal medical image and the abnormal medical image from the image storage server 14 via the network I/F 25. In step S12, as described above, the generation unit 42 determines a position of an indirect finding associated with the occurrence of the lesion based on the normal medical image and the abnormal medical image acquired in step S10 and the trained model 32, and generates a medical image in which the indirect finding is generated at a determined position in the normal medical image.

In step S14, the storage controller 44 performs control to store the medical image generated in step S12 in the storage unit 22. In a case in which the process in step S14 ends, the medical image generation process ends.

As described above, according to the present embodiment, it is possible to accurately generate a medical image of a lesion in an early stage. In addition, by executing the medical image generation process on each of a plurality of sets of the normal medical image and the abnormal medical image, a plurality of the generated medical images can be obtained. The plurality of generated medical images obtained as described above are used for training a trained model for detecting a lesion in an early stage from a medical image.

In the above embodiment, a case in which the generation unit 42 generates the medical image in which the indirect finding is generated at the determined position in the normal medical image has been described, but the present disclosure is not limited to this. The generation unit 42 may generate a medical image in which the indirect finding is generated at the determined position in the abnormal medical image.

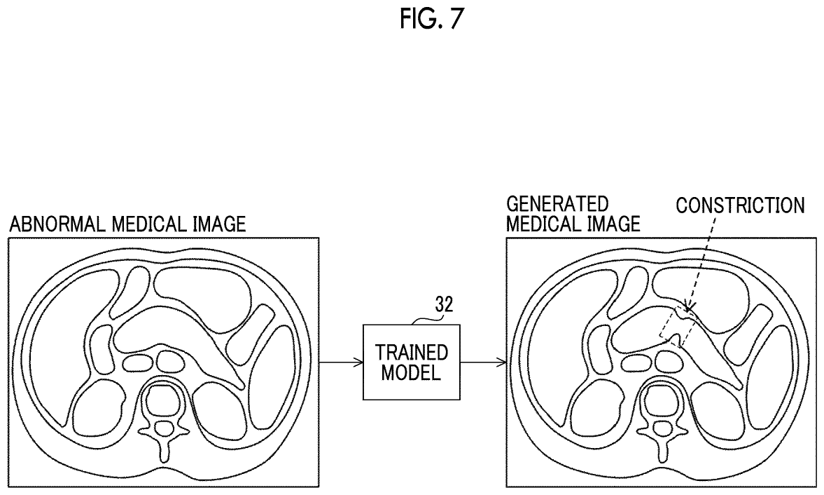

Specifically, as shown in FIG. 7, the generation unit 42 inputs the abnormal medical image acquired by the acquisition unit 40 to the trained model 32. The trained model 32 outputs a generated medical image in which an indirect finding is generated at a position of the lesion in the abnormal medical image. The trained model 32 in this embodiment example is also obtained by training the generator 32A and the discriminator 32B based on the abnormal medical image and the case data as in the above-described embodiment example.

In addition, in the above embodiment, a case in which the position of the lesion in the abnormal medical image is applied as the input information including the position of the lesion has been described, but the present disclosure is not limited to this. As the input information including the position of the lesion, a probability map in which a probability of occurrence of the lesion is defined for each position in the medical image may be applied. The probability map can be obtained, for example, by calculating a probability of occurrence of the lesion for each voxel of the medical image based on a plurality of medical images that have been captured in the past and in which the lesion has occurred.

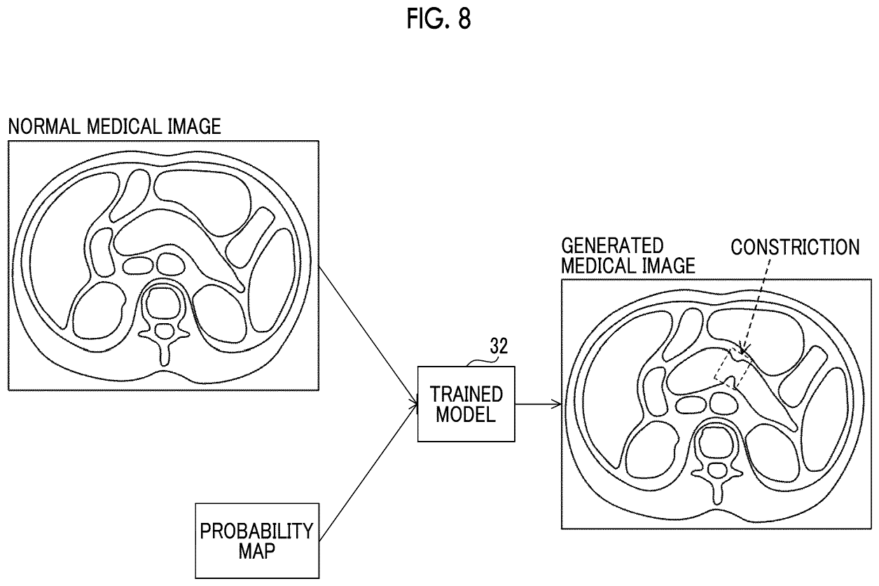

In this case, as shown in FIG. 8, the generation unit 42 inputs the probability map to the trained model 32 instead of the abnormal medical image. The trained model 32 determines a position of an indirect finding associated with the occurrence of the lesion in the medical image based on the probability map, and generates a medical image in which the indirect finding is generated at the determined position in the normal medical image. The trained model 32 in this embodiment example is also obtained by training the generator 32A and the discriminator 32B based on the normal medical image, the probability map, and the case data as in the above-described embodiment example.

In addition, for example, as the input information including the position of the lesion, data in which a value indicating existence of the lesion is defined in a region in which the lesion exists in the medical image may be applied. As an example of the data, an image (hereinafter, referred to as a “mask image”) is used in which “1” is stored in a voxel of a region in which the lesion exists in the abnormal medical image and “0” is stored in a voxel of a region other than the region in which the lesion exists.

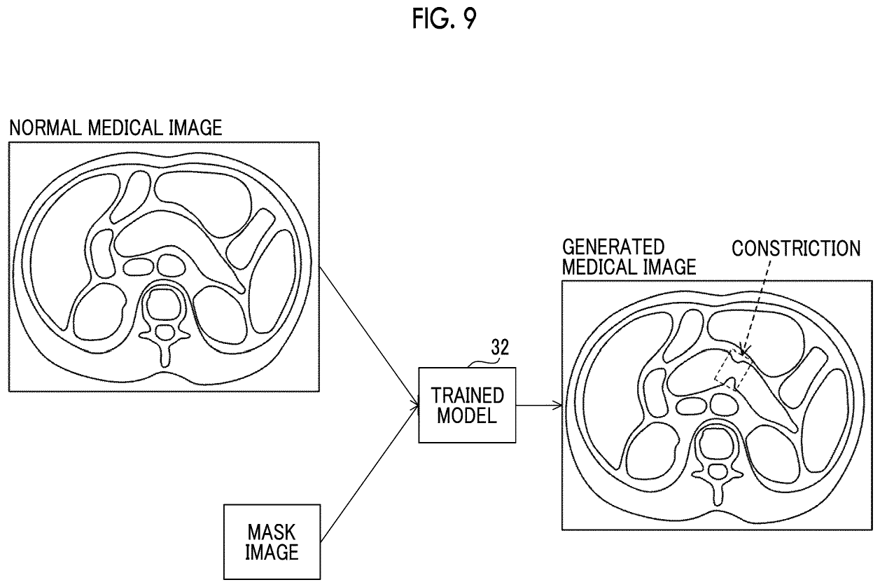

In this case, as shown in FIG. 9, the generation unit 42 inputs the mask image to the trained model 32 instead of the abnormal medical image. The trained model 32 determines a position of an indirect finding associated with the occurrence of the lesion in the medical image based on the mask image, and generates a medical image in which the indirect finding is generated at the determined position in the normal medical image. The trained model 32 in this embodiment example is also obtained by training the generator 32A and the discriminator 32B based on the normal medical image, the mask image, and the case data as in the above-described embodiment example. In addition, in this embodiment example, only the mask image may be input to the trained model 32. In this case, in addition to the mask image in which the value indicating the existence of the lesion is defined in the region in which the lesion exists, for example, a mask image in which an organ region in which the lesion exists stores a value indicating the organ is also input to the trained model 32.

In addition, in the above embodiment, a case in which the pancreatic cancer is applied as the lesion and the constriction is applied as the indirect finding has been described, but the present disclosure is not limited to this. For example, the pancreatic cancer may be applied as the lesion and the swelling of the pancreatic parenchyma may be applied as the indirect finding. In addition, for example, the pancreatic cancer may be applied as the lesion, and the atrophy of the pancreatic parenchyma that occurs on a tail part side of the pancreas with respect to an occurrence position of the pancreatic cancer may be applied as the indirect finding. In addition, for example, the pancreatic cancer may be applied as the lesion, and the dilatation of the pancreatic duct that occurs on a tail part side of the pancreas with respect to an occurrence position of the pancreatic cancer may be applied as the indirect finding. In addition, for example, the pancreatic cancer may be applied as the lesion, and the narrowing of the pancreatic duct that occurs at an occurrence position of the pancreatic cancer may be applied as the indirect finding.

In addition, the target organ is not limited to the pancreas. The disclosed technique can be applied to a medical image having a relationship between the occurrence position of the lesion and the occurrence position of the indirect finding that occurs in an early stage of the lesion.

In the above embodiment, a case in which the generator 32A and the discriminator 32B are configured by the CNN has been described, but the present disclosure is not limited to this. The generator 32A and the discriminator 32B may be configured by a machine learning method other than the CNN.

In addition, in the above embodiment, a case in which a CT image is applied as the medical image has been described, but the present disclosure is not limited to this. As the medical image, a medical image other than the CT image, such as a radiation image captured by a simple X-ray imaging apparatus and an MRI image captured by an MRI apparatus, may be applied.

In addition, in the above embodiment, for example, as hardware structures of processing units that execute various kinds of processing, such as the acquisition unit 40, the generation unit 42, and the storage controller 44, various processors shown below can be used. The various processors include, as described above, in addition to a CPU, which is a general-purpose processor that functions as various processing units by executing software (program), a programmable logic device (PLD) that is a processor of which a circuit configuration may be changed after manufacture, such as a field programmable gate array (FPGA), and a dedicated electrical circuit which is a processor having a circuit configuration specially designed to execute specific processing, such as an application specific integrated circuit (ASIC).

One processing unit may be configured of one of the various processors, or may be configured of a combination of the same or different kinds of two or more processors (for example, a combination of a plurality of FPGAs or a combination of the CPU and the FPGA). In addition, a plurality of processing units may be configured of one processor.

As an example in which a plurality of processing units are configured of one processor, first, as typified by a computer such as a client or a server, there is an aspect in which one processor is configured of a combination of one or more CPUs and software, and this processor functions as a plurality of processing units. Second, as typified by a system on chip (SoC) or the like, there is an aspect in which a processor that implements functions of the entire system including the plurality of processing units via one integrated circuit (IC) chip is used. As described above, various processing units are configured by using one or more of the various processors as a hardware structure.

Further, as the hardware structure of the various processors, more specifically, an electric circuit (circuitry) in which circuit elements such as semiconductor elements are combined may be used.

In the embodiment, an aspect has been described in which the image processing program 30 is stored (installed) in the storage unit 22 in advance, but the present disclosure is not limited to this. The image processing program 30 may be provided in an aspect in which the image processing program 30 is recorded in a recording medium, such as a compact disc read only memory (CD-ROM), a digital versatile disc read only memory (DVD-ROM), and a universal serial bus (USB) memory. In addition, the image processing program 30 may be downloaded from an external device via a network.

What is claimed is:

1. An image processing apparatus comprising:
at least one processor,
wherein the processor
determines a position of an indirect finding associated with occurrence of a lesion in a medical image based on input information including a position of the lesion, and
generates a medical image in which the indirect finding is generated at the determined position in a normal medical image in which the lesion has not occurred or in an abnormal medical image in which the lesion has occurred.

2. The image processing apparatus according to claim 1,
wherein the input information including the position of the lesion is a position of the lesion in the abnormal medical image.

3. The image processing apparatus according to claim 1,
wherein the input information including the position of the lesion is a probability map in which a probability of occurrence of the lesion is defined for each position in the medical image.

4. The image processing apparatus according to claim 1,
wherein the input information including the position of the lesion is data in which a value indicating existence of the lesion is defined in a region in which the lesion exists in the medical image.

5. An image processing method executed by a processor of an image processing apparatus, the method comprising:
determining a position of an indirect finding associated with occurrence of a lesion in a medical image based on input information including a position of the lesion; and
generating a medical image in which the indirect finding is generated at the determined position in a normal medical image in which the lesion has not occurred or in an abnormal medical image in which the lesion has occurred.

6. A non-transitory computer-readable storage medium storing an image processing program for causing a processor of an image processing apparatus to execute:
determining a position of an indirect finding associated with occurrence of a lesion in a medical image based on input information including a position of the lesion; and
generating a medical image in which the indirect finding is generated at the determined position in a normal medical image in which the lesion has not occurred or in an abnormal medical image in which the lesion has occurred.
